(19) United States
(12) Patent Application Publication
(10) Pub. No.: US 2024/0004737 A1
(43) Pub. Date: Jan. 4, 2024

(54) EVALUATION AND ADAPTIVE SAMPLING OF AGENT CONFIGURATIONS

(71) Applicant: Microsoft Technology Licensing, LLC, Redmond, WA (US)

(72) Inventor: Marco ROSSI, Harrisonburg, VA (US)

(73) Assignee: Microsoft Technology Licensing, LLC, Redmond, WA (US)

(21) Appl. No.: 17/852,757

(22) Filed: Jun. 29, 2022

(51) Int. Cl. G06F 9/54; G06F 11/34; G06N 20/20; G06N 5/02; G06K 9/62

(52) U.S. Cl. CPC G06F 9/547; G06F 11/3409; G06K 9/6262; G06N 5/025; G06N 20/20

(57) ABSTRACT

This document relates to evaluation of automated agents. One example includes a system having a processor and a storage medium. The storage medium can store instructions which, when executed by the processor, cause the system to perform two or more data gathering iterations, which can include distributing experimental units to a plurality of agents having different agent configurations according to a sampling strategy, populating an event log with events representing reactions of an environment to actions taken by individual agents in response to individual experimental units, and adjusting the sampling strategy for use in a subsequent data gathering iteration based at least on the events in the event log. The event log can provide a basis for subsequent evaluation of the plurality of agents with respect to one or more evaluation metrics.

### BACKGROUND

Conventionally, techniques such as A/B testing have been employed to evaluate different alternative configurations for various applications. For instance, A/B testing can be used to compare two different algorithms for a web search engine, or to compare two different user interface configurations for a social networking service. However, as discussed more below, A/B testing tends to be resource-intensive for scenarios where numerous configurations are being evaluated.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for evaluation of computer-based agents. One example includes a method or technique that can be performed on a computing device. The method or technique can include performing two or more data gathering iterations. Each data gathering iteration can include distributing experimental units according to a sampling strategy to a plurality of agents having different agent configurations. Each data gathering iteration can also include populating an event log with events representing reactions of an environment to actions taken by individual agents in response to individual experimental units. Each data gathering iteration can also include adjusting the sampling strategy for use in a subsequent data gathering iteration based at least on the events in the event log. The method or technique can also include predicting performance of the plurality of agents with respect to one or more evaluation metrics based at least on the events in the event log. The method or technique can also include identifying a selected agent configuration based at least on predicted performance of the plurality of agents with respect to the one or more evaluation metrics.

Another example includes a system having a hardware processing unit and a storage resource storing computer-readable instructions. When executed by the hardware processing unit, the computer-readable instructions can cause the hardware processing unit to perform two or more data gathering iterations. Each data gathering iteration can include distributing experimental units to a plurality of agents having different agent configurations according to a sampling strategy. Each data gathering iteration can also include populating an event log with events representing reactions of an environment to actions taken by individual agents in response to individual experimental units. Each data gathering iteration can also include adjusting the sampling strategy for use in a subsequent data gathering iteration based at least on the events in the event log. The event log can provide a basis for subsequent evaluation of the plurality of agents with respect to one or more evaluation metrics.

Another example includes a hardware computer-readable storage medium storing computer-readable instructions. When executed by the hardware processing unit, the computer-readable instructions can cause the hardware processing unit to perform acts. The acts can include obtaining an event log of events representing reactions of an environment to actions taken by a plurality of agents in response to individual experimental units. The acts can also include predicting performance of individual agents with respect to one or more evaluation metrics based at least on respective events in the event log reflecting respective actions taken by other agents. The acts can also include identifying a selected agent configuration based at least on predicted performance of the individual agents with respect to the one or more evaluation metrics. The acts can also include deploying a selected agent having the selected agent configuration.

The above listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example agent framework, consistent with some implementations of the present concepts.

FIG. 2 illustrates an example data gathering workflow, consistent with some implementations of the present concepts.

FIG. 3 illustrates an example data analysis workflow, consistent with some implementations of the present concepts.

FIG. 4 illustrates an example data structure for storing performance predictions, consistent with some implementations of the disclosed techniques.

FIG. 5 illustrates an example adaptive sampling workflow, consistent with some implementations of the present concepts.

FIGS. 6A, 6B, and 6C illustrate example graphical user interfaces that convey the performance of alternative agent configurations for evaluation metrics during adaptive sampling, consistent with some implementations of the present concepts.

FIG. 7A illustrates an example agent that can be configured to perform reinforcement learning, consistent with some implementations of the present concepts.

FIG. 7B illustrates an example agent that can be configured to perform supervised learning, consistent with some implementations of the present concepts.

FIG. 8 illustrates an example system, consistent with some implementations of the disclosed techniques.

FIG. 9 is a flowchart of an example method for evaluating agents using adaptive sampling strategies, consistent with some implementations of the present concepts.

FIGS. 10A and 10B illustrate example user experiences and user interfaces for content distribution scenarios, consistent with some implementations of the present concepts.

FIGS. 11A and 11B illustrate example user experiences and user interfaces for voice or video call scenarios, consistent with some implementations of the present concepts.

### DETAILED DESCRIPTION

### Overview

Traditionally, users that wish to select agents to perform computing tasks will compare the agents directly, using testing approaches such as A/B testing. In A/B testing, an experiment is conducted with two different agents and then the best-performing agent is selected by a user. Generally, computing resources are split evenly between the two agents, e.g., Agent A can execute on a processor for 100 samples, and Agent B can execute on the processor for another 100 samples. The samples collected by executing Agent A are used only to evaluate Agent A, and the samples collected by executing Agent B are used only to evaluate Agent B.

For scenarios where only two alternative agents are considered for a particular application, A/B testing works reasonably well. However, in some cases, a user would like to evaluate many different alternative agents in an efficient manner. A naive approach would be to run a tournament of A/B tests, but this can take a great deal of time and computational resources. For instance, in a tournament with four agents, two rounds, and 100 samples per agent per round, a total of 600 samples are collected—all four agents execute on the processor to collect 100 samples each in the first round, and then the two winning agents execute on the processor again to collect 100 samples each in the second round.

Now, consider a user that wants to evaluate several different classes of agents—supervised learning agents, unsupervised learning agents, reinforcement learning agents, and/or heuristic-based agents. Each class of agent can have different underlying algorithms, e.g., supervised learning can be implemented using neural networks, support vector machines, etc., or reinforcement learning can be implemented using policy iteration methods, contextual bandits, etc. Furthermore, each type of algorithm can have various model structures, hyperparameters, etc. The resulting search space of potential agent configurations is expansive, and as a consequence is impractical to conduct full A/B tests of all possible agent configurations.

The disclosed implementations can be used to evaluate different agent configurations by using samples collected by executing one agent to infer the performance of another agent. In other words, a sample collected by Agent A can be reused to infer the performance of Agent B. As a consequence, insight into the performance of different agents can be obtained using fewer computational resources than would be typically involved in A/B testing, where only samples collected by a given agent are used to evaluate the performance of that agent.

The disclosed implementations also can employ an adaptive sampling approach that uses agent behavior to change how sampling proceeds over time. For instance, in some cases, the probabilities that agents assign to individual actions during previously-collected samples can be used to adjust the probabilities that the agents are assigned to handle subsequent samples. In other cases, agents can be removed from future sampling based on their performance with respect to one or more evaluation metrics.

### Supervised Learning Overview

Supervise learning generally involves training an agent using labeled training data. In supervised learning, the agent updates its own internal model parameters based on a loss function defined over the labels. Supervised learning can be implemented using model structures such as support vector machines, neural networks, decision trees, etc. Supervised learning models can be used for tasks such as classification and/or regression. In some cases, a supervised learning model can output a probability distribution over a set of actions, e.g., assigning a 90% probability to take a first action given some set of inputs (e.g., context) and a 10% probability to take a second action.

Some machine learning frameworks, such as neural networks, use layers of nodes that perform specific operations. In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values.

### Reinforcement Learning Overview

Reinforcement learning generally involves an agent taking various actions in an environment according to a policy, and adapting the policy based on the reaction of the environment to those actions. Reinforcement learning does not necessarily rely on labeled training data as with supervised learning. Rather, in reinforcement learning, the agent evaluates reactions of the environment using a reward function and aims to determine a policy that tends to maximize or increase the cumulative reward for the agent over time.

In some cases, a reward function can be defined by a user according to the reactions of an environment, e.g., 1 point for a desired outcome, 0 points for a neutral outcome, and −1 point for a negative outcome. The agent proceeds in a series of steps, and in each step, the agent has one or more possible actions that the agent can take. For each action taken by the agent, the agent observes the reaction of the environment, calculates a corresponding reward according to the reward function, and can update its own policy based on the calculated reward.

Reinforcement learning can strike a balance between “exploration” and “exploitation.” Generally, exploitation involves taking actions that are expected to maximize the immediate reward given the current policy, and exploration involves taking actions that do not necessarily maximize the expected immediate reward but that search unexplored or under-explored actions. In some cases, the agent may select an action in the exploration phase that results in a greater cumulative reward than the best action according to its current policy, and the agent can update its policy to reflect the new information.

In some reinforcement learning scenarios, an agent can utilize context describing the environment that the agent is interacting with in order to choose which action to take. For instance, a contextual bandit receives context features describing the current state of the environment and uses these features to select the next action to take. A contextual bandit agent can keep a history of rewards earned for different actions taken in different contexts and continue to modify the policy as new information is discovered.

One type of contextual bandit is a linear model, such as Vowpal Wabbit. Such a model may output, at each step, a probability density function over the available actions, and select an action randomly from the probability density function. The model may learn feature weights that are applied to one or more input features (e.g., describing context) to determine the probability density function. When the reward obtained in a given step does not match the expected reward, the agent can update the weights used to determine the probability density function.

### Definitions

For the purposes of this document, an agent is an automated entity that can determine a probability distribution over one or more actions that can be taken within an environment, and/or select a specific action to take. An agent can determine the probability distribution and/or select the actions according to a policy. For instance, the policy can map environmental context to probabilities for actions that can be taken by the agent. Some agents can employ machine learning, e.g., an agent can be updated based on reactions of the environment to actions selected by the agent, either via a reward function (reinforcement learning) or a loss function (supervised learning). The term “internal parameters” is used herein to refer to learnable values such as weights that can be learned by training a machine learning model, such as a linear model or neural network. An experimental unit is a data item that an agent can act on, e.g., an experimental unit might specify a context and/or a set of actions for an agent to select from based on the context.

A machine learning model can also have hyperparameters that control how the agent acts and/or learns. For instance, a machine learning model can have a learning rate, a loss or reward function, an exploration strategy, etc. A machine learning model can also have a feature definition, e.g., a mapping of information about the environment to specific features used by the model to represent that information. A feature definition can include what types of information the model receives, as well as how that information is represented. For instance, two different feature definitions might both indicate that a model receives a context feature describing an age of a user, but one feature definition might identify a specific age in years (e.g., 24, 36, 68, etc.) and another feature definition might only identify respective age ranges (e.g., 21-30, 31-40, and 61-70).

An agent configuration is a specification of at least one characteristic of an agent, such as a rule, a model structure, a loss or reward function, a feature definition, or a hyperparameter. A policy is a function used to determine what actions that an agent takes in a given context. A policy can be static or can be learned according to an agent configuration. Note that policies for an agent can be defined heuristically or using a static probability distribution. For instance, an agent could use a uniform random sampling strategy from a set of available actions without necessarily updating the strategy in response to environmental reactions. A rule-based agent can have static rules that directly map context values to specific actions or action probabilities.

A particular agent configuration can be sampled by processing experimental units with an agent configured according to that agent configuration. A particular agent configuration can be evaluated by predicting how the agent configuration will perform with respect to one or more evaluation metrics, using data sampled by that agent configuration or other agent configurations. A particular agent configuration can be deployed by placing that agent configuration into service for a particular application, e.g., executing the particular agent configuration to select actions for a particular application in a production environment.

### Example Learning Framework

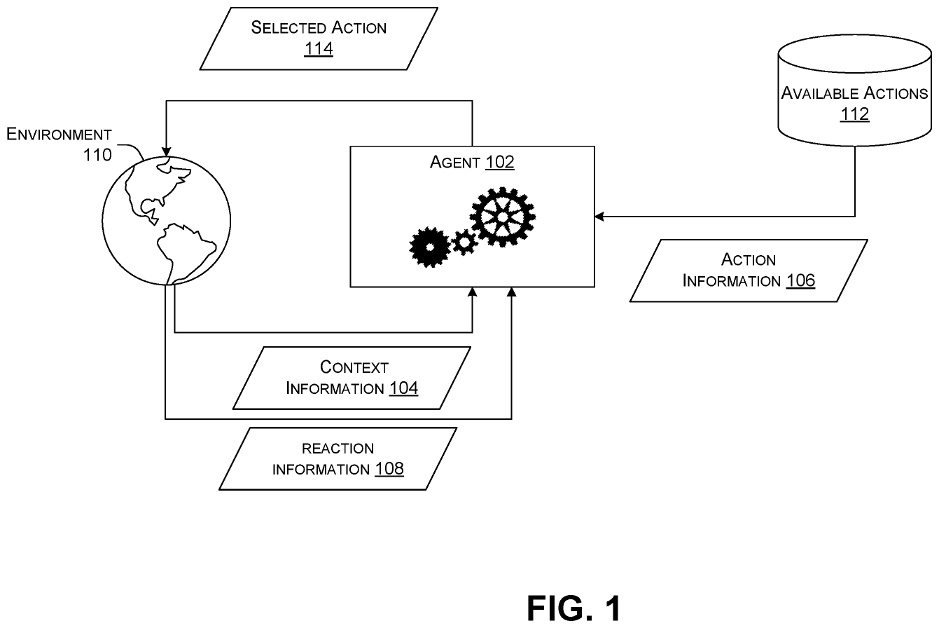

FIG. 1 shows an example where an agent 102 receives context information 104, action information 106, and reaction information 108. The context information represents a state of an environment 110. The action information represents one or more available actions 112. The agent can choose a selected action 114 based on the context information. The reaction information can represent how the state of the environment changes in response to the action selected by the agent. For reinforcement learning models, reaction information 108 can be used in a reward function to determine a reward for the agent 102 based on how the environment has changed in response to the selected action. In some cases, reactions can be labeled by manual or automated techniques for training of supervised learning agents.

In some cases, the actions available to an agent can be independent of the context—e.g., all actions can be available to the agent in all contexts. In other cases, the actions available to an agent can be constrained by context, so that actions available to the agent in one context are not available in another context. Thus, in some implementations, context information 104 can specify what the available actions are for an agent given the current context in which the agent is operating.

### Example Data Gathering Workflow

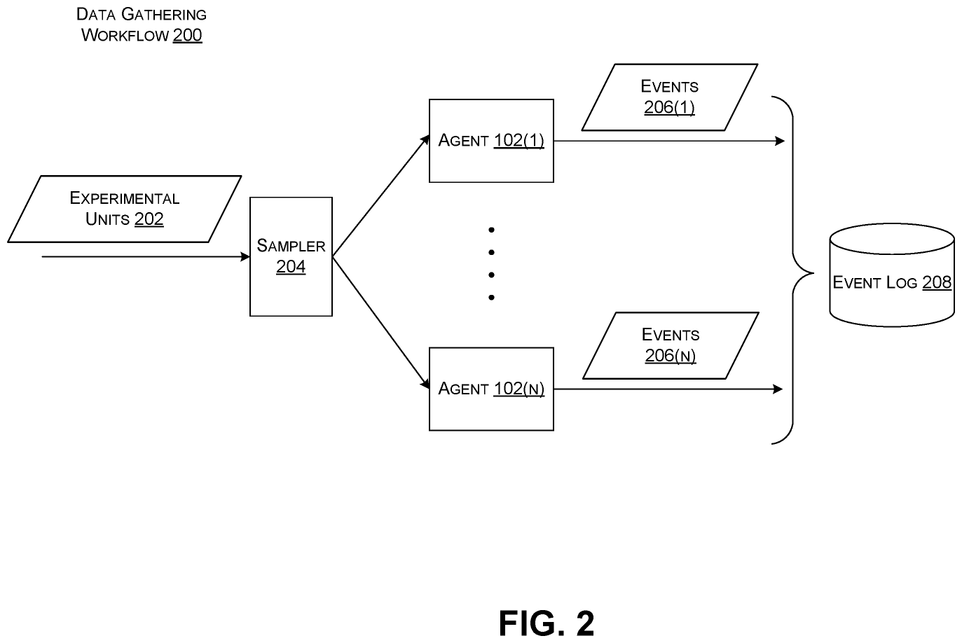

FIG. 2 shows an example data gathering workflow 200 where experimental units 202 are received and sampled by a sampler 204. The sampler distributes individual experimental units among multiple agents 102(1) . . . 102(N) according to a sampling policy, where N is the size of a sampling pool of agents. Each agent outputs a corresponding group of events 206(1) . . . 206(N) which are used to populate an event log 208. As discussed more below, each event can include information such as the context in which a given agent took an action, the action taken, the reaction of the environment to the action, and/or the probability that the agent assigned to the action that was taken. Each agent can have a different agent configuration, and thus the agents may assign different probabilities to different actions even given identical experimental units.

As noted previously, the experimental units 202 can include any data over which an agent can select an action. In some cases, experimental units include both context information and action information, and in other cases include only context information. As sampling proceeds over multiple sampling iterations, the sampler 204 can adjust the probability with which individual agents are assigned to handle individual experimental units. As discussed more below, this can allow the sampler to sample data in a manner that allows the resulting event logs to be used to evaluate multiple different agent configurations in an efficient manner. In some cases, the event log can be used to evaluate other agents that were not sampled when populating the event log.

### Example Data Analysis Workflow

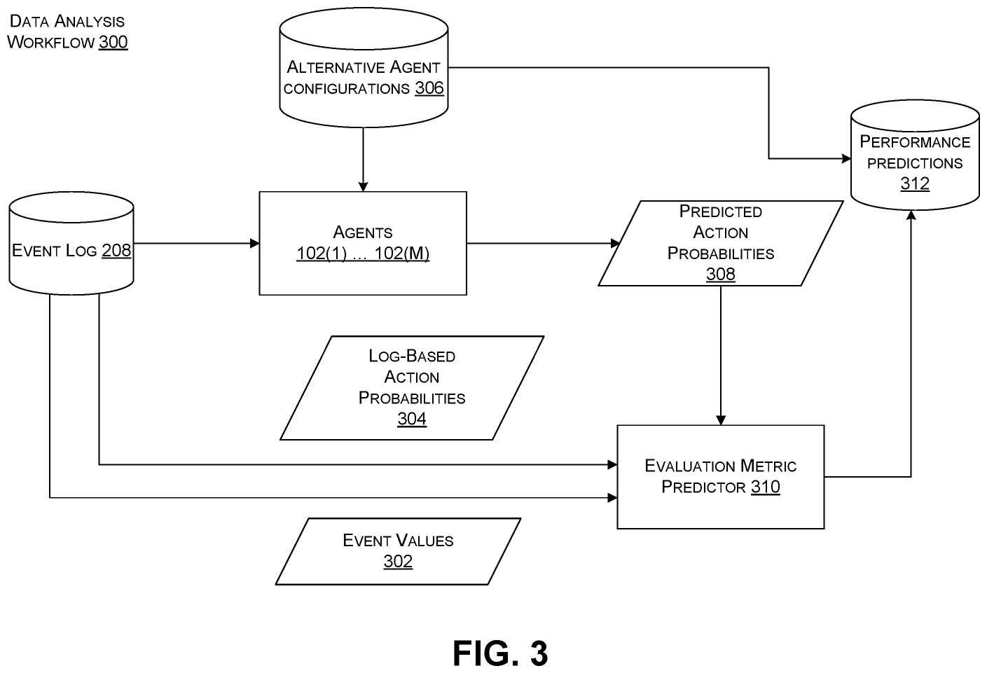

FIG. 3 shows an example data analysis workflow 300 where event log 208 is processed to predict performance of different agent configurations 102(1) . . . 102(M), as described more below. As noted previously, the event log can be obtained by sampling agents 102(1) . . . 102(N) to process experimental units according to their respective agent configurations. In some cases, M is greater than N, e.g., performance can be predicted for M=100 agent configurations based on sampling by N=25 agent configurations. In this case, the M alternative agent configurations could include 75 agent configurations that were not sampled when populating the event log.

The term “log agent” is used herein to refer to whichever agent produced a particular event in the event log, e.g., when assigned a given experimental unit by the sampler. The term “log agent configuration” is used herein to refer to the configuration of the log agent. As noted previously, each event in the event log can identify a context associated with an experimental unit, an action taken by the agent, and a reaction of the environment to the action taken by the agent. Event values 302 can be determined for each event, where the event values reflect the value of that event with respect to one or more evaluation metrics. In some cases, the event values are determined using a function to map reactions and, optionally, contexts and actions, to the event values, as described more below.

Log-based action probabilities 304 can be determined for each event in the event log 208, where the log-based action probabilities represent the likelihood that the log agent calculated for each event in the log for each action that was taken. Thus, assume that a particular event in the event log indicates that, for a given context associated with that event, the agent determined a probability density function of {Action A==Action B==0.3}. If the log agent took Action A for that particular event, then the log-based action probability for that event is 0.7, and if the agent took action B for that particular event, then the log-based action probability for that event is 0.3.

Agents 102(1) . . . 102(M) can be configured according to various alternative agent configurations 306. The events in the event log 208 can be replayed using an agent configured in each of the alternative event configurations, so that each alternative event configuration can be used to process the events in the event log offline. For each event in the event log, predicted action probabilities 308 can be predicted. Here, the predicted action probabilities represent the probability that the agent would have taken the action that was taken in the event log had the corresponding alternative agent configuration been used instead of the log agent configuration. Thus, for instance, assume that alternative agent configuration 1 calculated a probability density function of {Action A==Action B==0.2} for a particular event in the event log. If the event log indicates that the agent took Action A for that event (e.g., when configured by the log agent configuration), then the predicted action probability for that event is 0.8 for alternative agent configuration 1. If the event log indicates that the agent took Action B for that event, then the predicted action probability for that event is 0.2 for alternative agent configuration 1.

Evaluation metric predictor 310 can predict aggregate values of one or more evaluation metrics for each alternative agent configuration to populate performance predictions 312. Here, each performance prediction conveys how a particular alternative agent configuration is predicted to perform for a particular evaluation metric. By comparing how different agent configurations are predicted to perform for different evaluation metrics, a selected agent configuration can be identified.

### Example Performance Prediction Data Structure

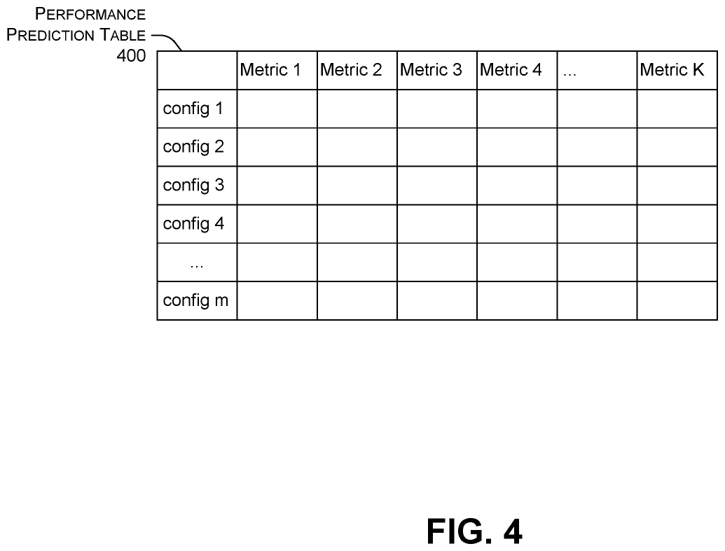

FIG. 4 illustrates a performance prediction table 400, which is one example of a data structure that can be used to store performance predictions 312. Each row of performance prediction table 400 represents a different alternative agent configuration, and each column of the table represents a different evaluation metric. As noted previously, the evaluation metrics can be based on a function that maps environmental reactions, and optionally selected actions and/or context, to a value for a given evaluation metric.

Examples of evaluation metrics and corresponding functions for specific applications are detailed below, but at present, consider the following brief example. Assume a function defines the following values for Metric 1:
for events having reaction 1 when action 1 is selected by the agent in a first context, the value of Metric 1 is 1;
for events having reaction 1 when action 1 is selected by the agent in a second context, the value of Metric 1 is 2;
for events having reaction 1 when action 2 is selected by the agent in the first context, the value of Metric 1 is 10;
for events having reaction 1 when action 2 is selected by the agent in a second context, the value of Metric 1 is 8;
for events with reaction 2, the value of Metric 1 is 0 irrespective of the action selected by the agent or the context.

Using this function, each event in the event log can be extracted and the value of Metric 1 can be determined for that event based on the action that the agent actually took, the context in which the agent took that action, and the reaction of the environment. Then, that value of Metric 1 can be adjusted for each alternative agent configuration as follows. Multiply the value of Metric 1 by the probability that a particular alternative agent configuration would have been given to the same action given the same context for that event, divide that number by the probability that the agent gave to that selected action when in the log agent configuration, and add that value to the column for Metric 1 for the row of the particular agent configuration. These calculations can be performed for every event in the log. The resulting values convey the expected value of Metric 1 in the first column of performance prediction table 400 for each alternative agent configuration. These steps can be performed for different evaluation metrics (e.g., calculated using different functions) to populate the remainder of the table.

### Specific Algorithm

The following provides a more detailed definition of variables and formulas that can be used to populate performance prediction table 400. The term “log agent” is used below to refer to the agent when configured according to the log agent configuration. In other words, “log agent” refers to the configuration state of the agent when the events were collected in the event log 208. For each event in the event log, define the following:
x (vector): this is called context of the decision. It contains the environment (context) features, the possible actions for the agent for each event, and action features for the available actions. The context features describe the environment in which the agent selects a particular agent;
a (index): the action actually taken by the log agent (out of the possible options specified in x);
p_log (scalar between 0 and 1): probability with which the log agent took action a, as indicated in the event log;
y (vector): vector of observation features that describes the reaction of the environment to the action a picked by the log agent;
r (vector): This vector defines the multi-dimensional value of that event, e.g., r is one way to represent a function that maps events to values of one or more evaluation metrics. Each entry in the vector represents the value of a particular evaluation metric of having selected action a in context x given observation features y were measured. This vector can be user-specified at the time that the alternative agent configurations are evaluated using the events in the log.

For each event in the event log 208, the expected value of that event with respect to a particular evaluation metric for a given alternative agent configuration can be calculated as follows:

$${\sum }_{e vent i} {r}_{i} \frac{{P}_{i} ( Alternative Configuration )}{{P}_{i} ( Log Agent )}$$

As noted above, rᵢ represents the value of the vector r given the action taken by the log agent, the context in which the action was taken, and the reaction of the environment. Thus, for example, if rᵢ for a given event is {1, 4, . . . 27} given a K-dimensional vector, this means that the event has a value of 1 for evaluation metric 1, a value of 4 for evaluation metric 2, and a value of 27 for evaluation metric K.

Each of the values in rᵢ can be adjusted by multiplying the value by the probability that a given alternative agent configuration would have given to the action taken in the log, divided by the probability that the log agent gave to that action. Thus, this value essentially weights the value of the rᵢ vector higher for the alternative agent configuration if the alternative agent configuration was more likely to have taken the action than the log agent given the context of that event, and lower if the alternative agent configuration was less likely to have taken the action than the log agent given the context of that event.

Note that some implementations may also define constraints on which alternative agent configurations should be considered. For instance, one constraint might specify that only alternative agent configurations with at least a value of 1000 for a particular evaluation metric are considered. Any agent configuration with a lower value can be filtered out prior to selecting a new agent configuration from the remaining available configurations.

### Generalizations

As described above, each column can represent the predicted performance of a given evaluation metric computed over the individual events in the event log 208. In some cases, however, evaluation metrics can be computed over episodes of multiple events. For instance, an episode can be specified as a constant number (e.g., every 10 events), a temporal timeframe (e.g., all events occurring on a given day), or any other grouping of interest to a user. Episode values computed over an entire episode of events can be used in place of individual event values to determine performance predictions.

In addition, the previous description can be used to compute the mean expected value of each evaluation metric. However, further implementations can consider other statistical measures, such as median, percentile values (e.g., 10^{th}, 50^{th}, 90^{th}), standard deviation, etc. These statistical measures can be computed over each individual event in the log or over episodes of multiple events. In addition, confidence intervals can be computed for each statistical measure.

The following formulation:

$$Cell ( {agent}_{j} , {metric}_{k} ) := {f}_{k} ( {[ {r}_{i , k} , {p}_{i , j} ]}_{i ∈ {I}_{k}} ) \pm \begin{matrix}Confidence \\ Interval\end{matrix}$$

$$Where : \{ \begin{matrix}\begin{matrix}\begin{matrix}{I}_{k} : indices of episodes for metric k \\ {r}_{i , k} : value of episode i for metric\end{matrix} \\ {p}_{i , j} = \frac{{p}_{i}}{{φ}_{j}} \frac{p ( {episode}_{i} \vert {agent}_{j} )}{p ( {episode}_{i} \vert log )}\end{matrix} \\ {φ}_{j} = {\sum }_{i} {p}_{i} \frac{p ( {episode}_{i} \vert {agent}_{j} )}{p ( {episode}_{i} \vert log )}\end{matrix}$$

can be employed to calculate a given statistical measure for any event episode definition.

### Adaptive Sampling Workflow

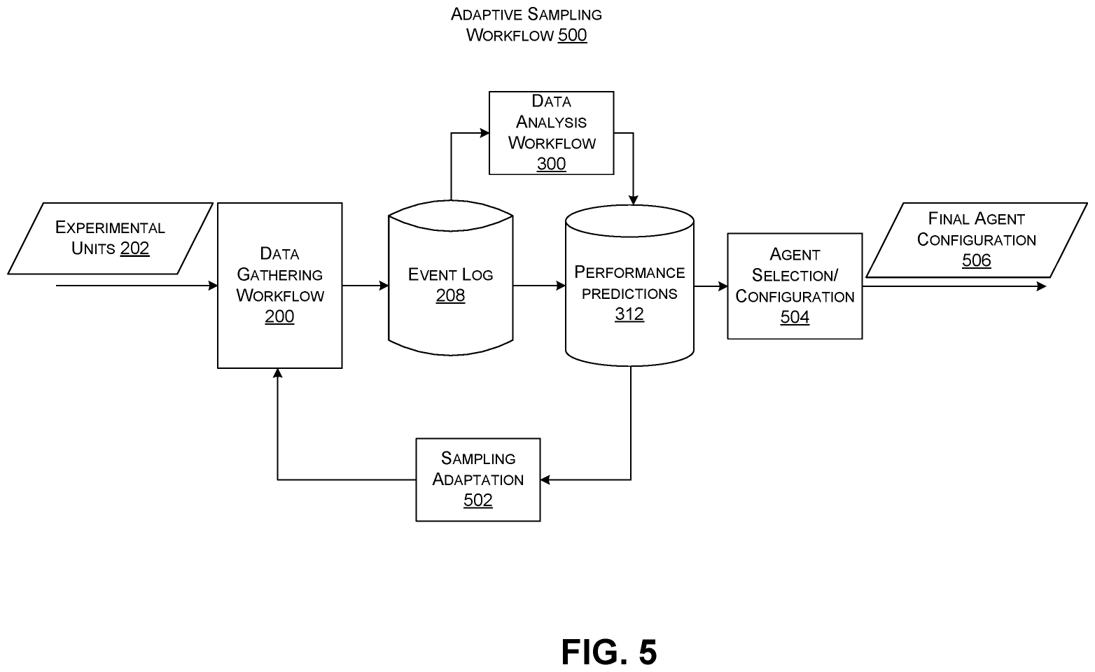

FIG. 5 shows an adaptive sampling workflow 500 that integrates processing described above with respect to data gathering workflow 200 and data analysis workflow 300. Experimental units 202 are input to the data gathering workflow 200 to populate event log 208, as previously described. Data analysis workflow 300 is performed on the event log to generate performance predictions 312.

Next, sampling adaptation 502 is performed based on the performance predictions 312. Generally speaking, sampling adaptation can adjust the sampling probabilities for each agent 102(1) . . . 102(N) in data gathering workflow 200. Upon reaching a termination condition, agent selection/configuration 504 is performed to select a final agent configuration 506 from a set of M agent configurations that can include the N agent configurations that were sampled as well as additional agent configurations that were not sampled.

In some cases, sampling adaption can offer different sampling modes. In a first sampling mode, users can manually define the sampling probabilities for each agent configuration. For instance, the user might decide to evaluate six agent configurations A, B, C, E, F, and G. The user can designate agent configurations A, B, and C to be sampled with an equal (e.g., 33%) sampling probability for a first data gathering iteration, with zero probabilities for agent configurations E, F, and G. The user might decide to eliminate Agent C from subsequent data gathering iterations and then evaluate the remaining two agent configurations with more emphasis on one agent, e.g., 60% probability for Agent A and 40% for Agent B. Performance can be predicted for all six agent configurations based on data gathered only by agent configurations A, B, and C, and then any of the six agent configurations can be selected for deployment.

In a second sampling mode, sampling probabilities for each agent configuration can be determined according to an importance weighting scheme. In the importance weighting scheme, the probabilities that individual agents give to the actions in the event log are divided by the probabilities of the actions taken by the log agent to determine importance weights for each event. The resulting values are then summed for each agent and divided by the number of events in the event log to obtain average importance weights for each agent. Subsequently, z=abs(ln(average of importance weights) is used as a sampling metric that can be calculated for each agent configuration. Then, a probability distribution over the agent configurations can be determined based on this sampling metric as described more below.

One way to employ sampling metric z involves removing individual agent configurations from sampling prior to subsequent data gathering iterations. For instance, users may define a number of agent configurations X that should be used for sampling in each data gathering iteration, e.g., X={N, 10, 5} for three data gathering iterations. In each data gathering iteration, z can be calculated for each agent configuration using the sampled data obtained thus far, and then the X agent configurations with the highest values of z can be assigned a uniform sampling probability 1/X in the next data gathering iteration.

Assuming N=25, then 25 agent configurations are sampled with equal probability in the first sampling iteration. Then, the ten agents with the highest z values out of the N agents sampled in the first data gathering iteration are sampled with equal probability in the second data gathering iteration, while 15 agents are excluded from sampling (e.g., assigned sampling probabilities of 0). Then, the five agents with the highest z values out of the ten agents sampled in the second data gathering iteration are sampled with equal probability in the third data gathering iteration, with an additional 5 agents being excluded from sampling. In other cases, sampling probabilities can be determined for each data gathering iteration by applying a function such as softmax to the values of z determined in the previous data gathering iteration.

Generally speaking, when the average importance weight for a given agent is close to 1, this indicates that the already-collected data can accurately predict the performance of that agent. In contrast, when the average importance weight for a given agent get further away from 1, this indicates that the already-collected data is less accurate for predicting the performance of that agent. In the uniform sampling probability example given above, agent configurations with average importance weights close to 1 tend to be removed from subsequent data gathering iterations, thus allowing the other agent configurations for which the existing samples are relatively less predictive to obtain more samples. Using a softmax function instead of uniform sampling has the additional benefit that higher sampling probabilities tend to be assigned to those agent configurations for which the already-sampled data provides relatively low confidence for predicting performance, and lower sampling probabilities assigned to those agent configurations for which the already-sampled data provides relatively high confidence for predicting performance. Thus, each subsequent data gathering iteration tends to emphasize gathering new samples for certain agents in a manner that increases the overall confidence with which the performance of the M agents can be predicted.

In a third sampling mode, sampling proceeds by determining the sampling probabilities based on performance of individual agents with respect to one or more evaluation metrics. For instance, assume that a user has designated a single evaluation metric for which they would like to maximize the average value. One way to proceed is to determine the upper bound of each agent configuration for that evaluation metric (e.g., upper bound of the 95% confidence interval). Then, this upper bound can be employed as a sampling metric in a manner that is similar to that described above with respect to z for the second sampling mode.

In each data gathering iteration, the X agent configurations with the highest values of the upper bound for a given evaluation metric can be assigned a uniform probability 1/X in the next data gathering iteration. In this example, all N=25 agent configurations are sampled with equal probability in the first sampling iteration. Then, the ten agents with the highest upper bound for the selected evaluation metric out of the 25 agents sampled in the first data gathering iteration are sampled with equal probability in the second data gathering iteration, with 15 agents excluded from sampling. Then, the five agents with the highest upper bound out of the ten agents sampled in the second data gathering iteration are sampled with equal probability in the third data gathering iteration, with an additional 5 agents excluded from sampling. In other cases, sampling probabilities can be determined for each data gathering iteration by applying a function such as softmax to the values of the upper bound determined in the previous data gathering iteration.

For some cases, users may be interested in minimizing rather than maximizing a given evaluation metric. If so, the opposite value can be maximized instead, e.g., if the user wishes to minimize a given evaluation metric, then the upper bound of the opposite (e.g., negative) value for that metric can be employed as a sampling metric. For cases where users wish to consider multiple evaluation metrics, the user can provide corresponding weights or coefficients for each evaluation metric of interest to define the sampling metric. For instance, if the user selects a weight of 2 for evaluation metric 1 and a value of 5 for evaluation metric 3, then the sampling metric can be computed as (2*evaluation metric 1)+(5*evaluation metric 3) and employed as described previously using uniform and/or softmax-derived probabilities.

As sampling proceeds, the confidence intervals will tend to grow smaller. By assigning higher sampling probabilities to those agents with higher upper bounds of the confidence intervals, each subsequent data gathering iteration tends to emphasize gathering new samples for those agents in a manner that reduces the confidence intervals for the evaluation metrics and tends to prioritize sampling agent configurations with potentially-optimal performance for one or more evaluation metrics. As the confidence intervals for two different agents grow smaller, at some point one agent may be said to statistically “dominate” another. In other words, it is statistically unlikely that Agent A will outperform Agent B for one or more evaluation metrics given the confidence intervals of those metrics. In that case, Agent A can be automatically removed from subsequent data gathering iterations.

Note that the first and second sampling modes can be performed without a function that defines evaluation metrics. The first sampling mode can be implemented without any knowledge of the resulting events in the event log 208 from previous sampling iterations. The second sampling mode can adjust sampling based on the event log without determining performance predictions for the agents. The third sampling mode generally involves using the performance predictions to inform the sampling strategies for future data gathering iterations.

### Example Sampling Adaptation for Third Sampling Mode

The following shows various graphical representations that convey how sampling probabilities for different alternative agent configurations can change over data gathering iterations based on different predicted performance of the agent configurations for different evaluation metrics.

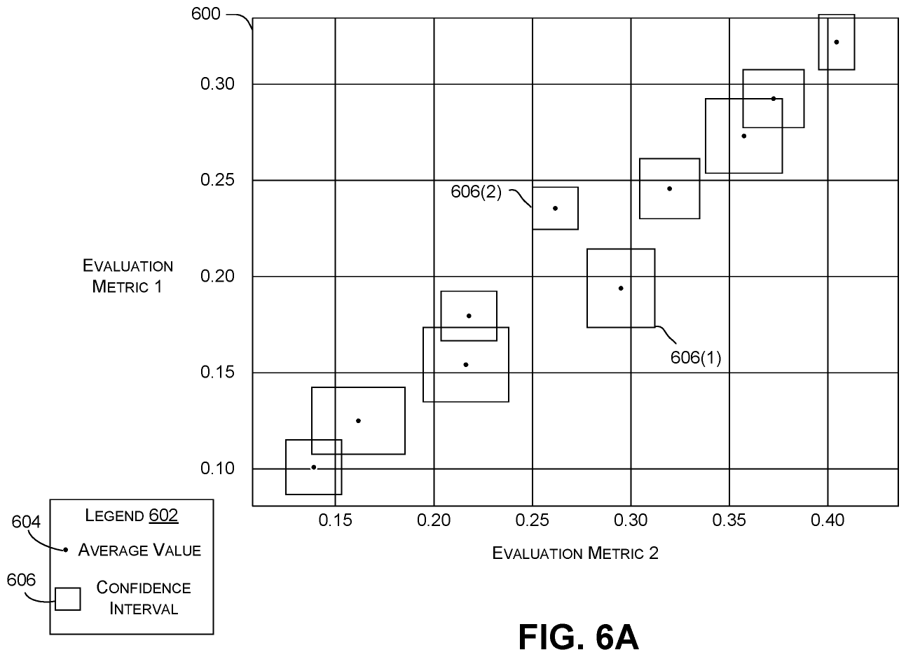

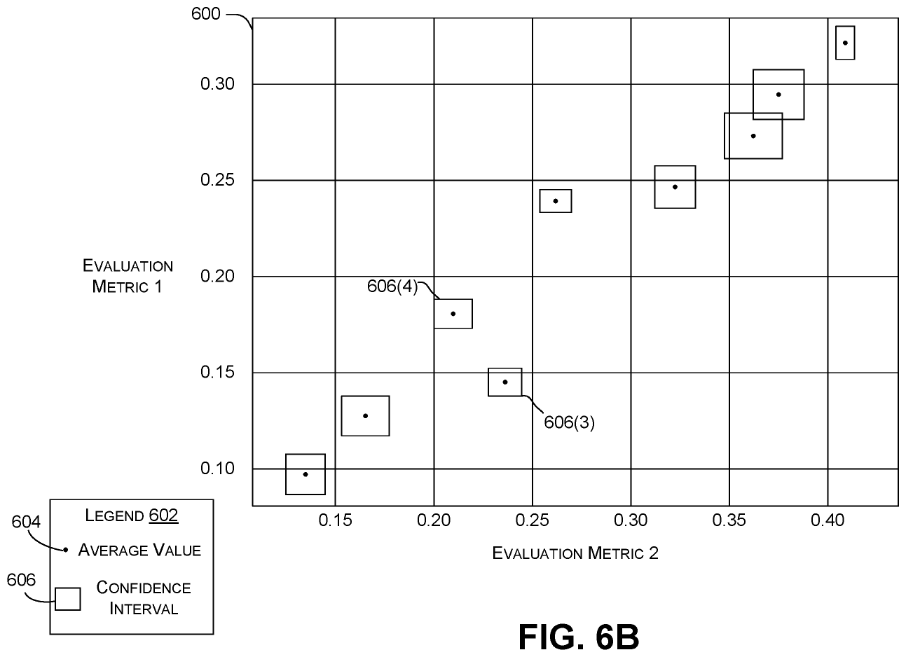

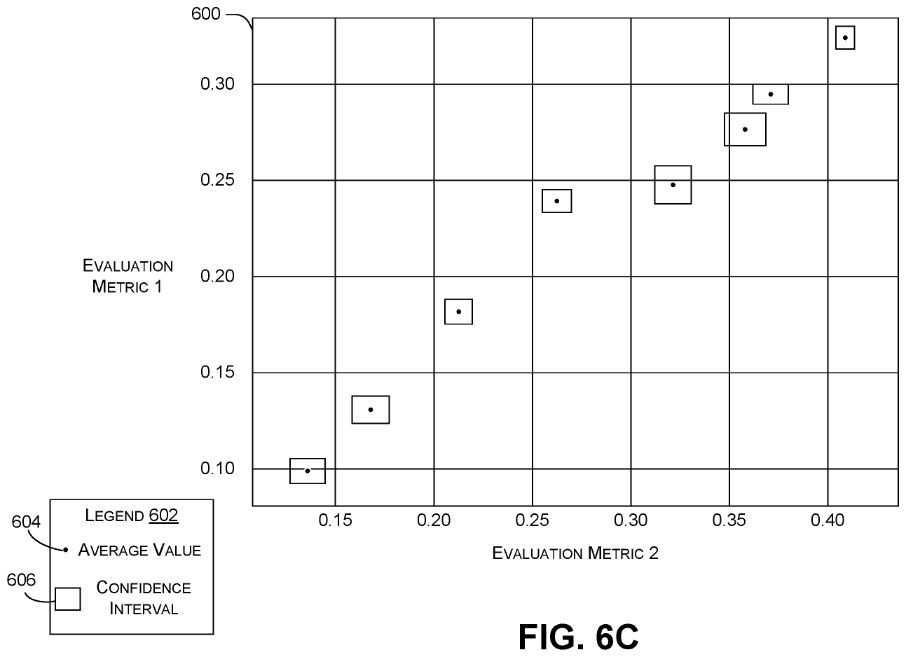

FIGS. 6A, 6B, and 6C illustrate an example output plot 600 with a y axis representing an evaluation metric 1 and an x axis representing an evaluation metric 2. FIG. 6A represents a state of the plot after a first data gathering iteration, FIG. 6B represents a state of the plot after a second data gathering iteration, and FIG. 6C represents a state of the plot after a third data gathering iteration. Assume for the purposes of the following example that agent configurations are automatically removed from sampling when they become statistically dominated by other agent configurations. Alternative approaches are described in more detail below.

Each entry on plot 600 represents aggregate values for the evaluation metrics that are predicted for a corresponding agent configuration. As shown in legend 602, the various alternative agent configurations are represented by round black dots 604 and rectangles 606. Each round black dot conveys the predicted aggregate values of evaluation metrics 1 and 2 for the agent in a different alternative agent configuration. Each rectangle shows a 95^{th} percentile confidence interval with respect to each metric. Thus, plot 600 represents, in graphical form, how different alternative agent configurations are predicted to perform for two different evaluation metrics and the relative confidence in each metric given the currently-sampled data in the event log.

Assume for the purposes of the following examples that a user generally would like to maximize the value of evaluation metric 1 while minimizing the value of evaluation metric 2. Observe, however, this involves certain trade-offs, as the value of evaluation metric 2 tends to increase as evaluation metric 1 increases. In other words, those alternative agent configurations with higher values for evaluation metric 1 tend to also result in relatively higher values for evaluation metric 2.

Thus, generally speaking, any first point that is both above and to the left of a second point on plot 600 can be said to “dominate” the second point. In other words, the second point has both a lower value of evaluation metric 1, which the user would like to maximize, and a higher value of evaluation metric 2, which the user would like to minimize.

In FIG. 6A, most of the rectangles 606 have at least one point that is at least one of above or to the left of at least one point in another rectangle. However, note that every point in rectangle 606(1) is both below and to the right every point in rectangle 606(2). Subject to the statistical limitations of the confidence interval, it is apparent that the corresponding agent configuration for rectangle 606(1) is strictly inferior to the agent configuration for rectangle 606(2). In other words, rectangle 606(1) does not contain any point on the Pareto frontier of possible agent configurations.

One way to implement sampling adaptation 502 in adaptive sampling workflow 500 is to filter out any agent configuration that does not have a point on the Pareto frontier, e.g., assign that agent configuration a zero sampling probability for the next round of sampling. FIG. 6B shows an example after filtering, e.g., rectangle 606(1) and its corresponding agent configuration have not been sampled. The remaining agent configurations continue to be sampled, and as a consequence each rectangle is smaller in size as the respective confidence intervals for both metrics grow smaller. As noted previously, the sampling probabilities of the remaining agents in each subsequent iteration can be uniform or proportional to the upper bound of one or more of the metrics being considered.

In FIG. 6B, note that rectangle 606(3) is now dominated by rectangle 606(4). Thus, the agent configuration for rectangle 606(3) can be filtered from further sampling in the next data gathering iteration. Note that the averages and confidence intervals can change over data gathering iterations.

FIG. 6C shows 8 remaining rectangles. Since none of the rectangles fully dominates another, no filtering is performed in the data gathering iteration represented by FIG. 6C. Further sampling and evaluation can be performed as described previously. A final configuration can be selected from the 8 remaining configurations either automatically or based on user input, e.g., directed to a GUI as shown in FIG. 6C.

The description above assumes automated filtering of agent configurations at each data gathering iteration based on statistical dominance, and can be performed in a fully automated manner without user input. In further implementations, however, user input can be used to guide how sampling proceeds over subsequent data gathering iterations. For instance, as noted previously, users can specify how many configurations are to be evaluated in each data gathering iteration, in which case only the top agent configurations from the previous data gathering iteration are sampled at each subsequent iteration.

In further cases, users may specifically select one or more agent configurations via a GUI to designate those configurations to include (or exclude) for use in further data gathering iterations. This can also involve scenarios where users can view multiple different GUIs that illustrate agent performance for different evaluation metrics. For instance, a user might provide input requesting a first plot of evaluation metrics 1 and 2 and select 10 agent configurations from the first plot. Then, the user might provide input requesting a second plot of evaluation metrics 3 and 4 and select 5 additional agent configurations from the second plot, to select a total of 15 agent configurations to be sampled in the next data gathering iteration. As individual configurations are selected, they can be graphically distinguished from other configurations so that the user can tell which configurations have already been selected via a previous plot. This allows users to view and select different “slices” of agent configurations for further sampling according to performance with respect to metrics that interest the user.

Users can also be provided with options to configure sampling probabilities. For instance, users can choose between uniform or softmax-based sampling for both the second and third sampling modes. For instance, a user with relatively little technical knowledge might prefer a uniform sampling approach, whereas a user with more technical knowledge might prefer a softmax-based sampling approach. In some cases, users can also be provided the ability to adjust softmax-based sampling probabilities.

### Example Agent Types

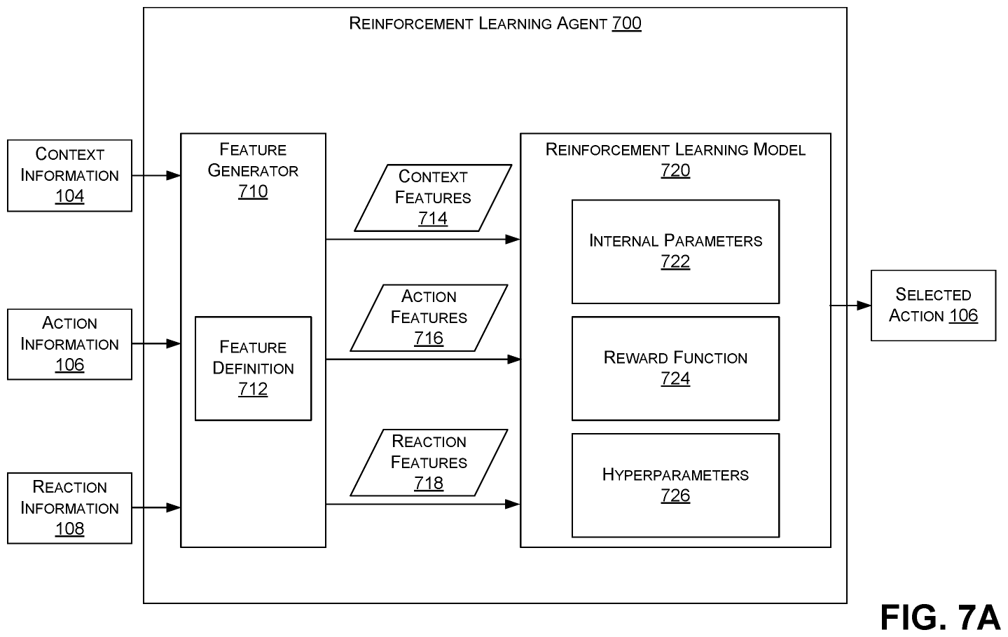

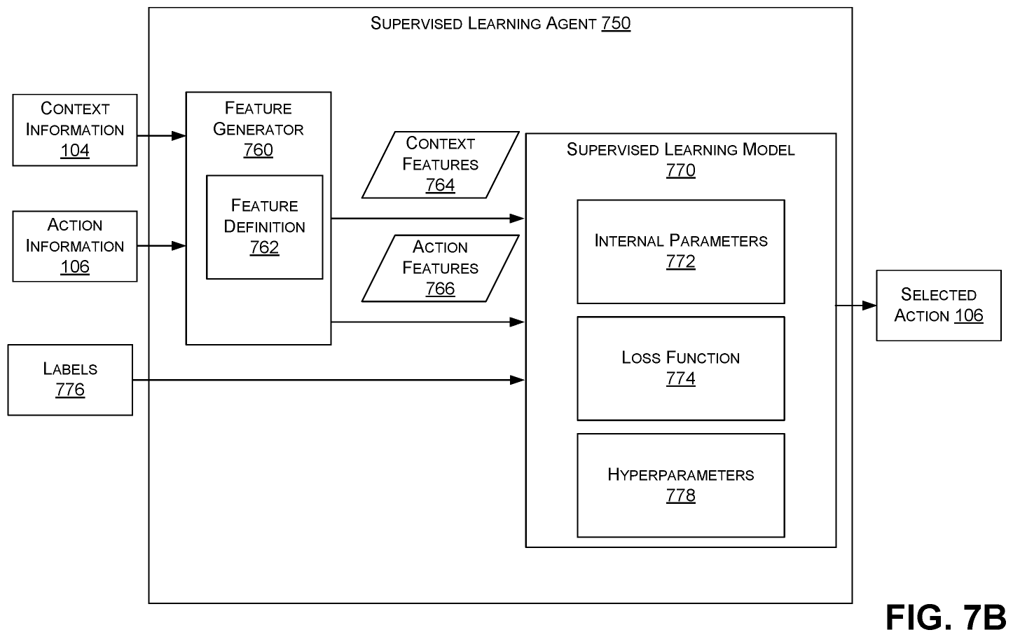

The disclosed implementations can be used to evaluate many different types of agents. FIGS. 7A and 7B illustrate examples of agent components of two specific types of agents, as discussed more below.

FIG. 7A illustrates components of a reinforcement learning agent 700, which includes a feature generator 710 and a reinforcement learning model 720. The feature generator uses feature definition 712 to generate context features 714 from context information 104, action features 716 from action information 106, and reaction features 718 from reaction information 108. The context features represent a context of the environment in which the agent is operating, the action features represent potential actions the agent can take, and the reaction features represent how the environment reacts to an action selected by the agent. Thus, the reaction information may be obtained later in time than the context information and action information. The reinforcement learning model 720 uses internal parameters 722 to determine selected action 114 from the context features 714 and the action features 716. The reward function 724 calculates a reward based on the reaction features. The hyperparameters 726 can be used to adjust the internal parameters of the reinforcement learning model based on the value of the reward function.

FIG. 7B illustrates components of a supervised learning agent 750, which includes a feature generator 760 and a supervised learning model 770. The feature generator uses feature definition 762 to generate context features 764 from context information 104 and action features 766 from action information 106. The context features represent a context of the environment in which the agent is operating, and the action features represent potential actions the agent can take. The supervised learning model 770 uses internal parameters 772 to determine selected action 114 from the context features 764. During training, a loss function 774 can be applied to labels 776, where each label indicates a correct action. The hyperparameters 726 can be used to adjust the internal parameters of the supervised learning model based on the value of the loss function.

As noted previously, disclosed implementations can also be employed to evaluate other types of agents, such as unsupervised learning agents, rule-based agents, etc.

### Technical Effect

The disclosed implementations can predict how different agent configurations will perform for different evaluation metrics using an adaptive sampling approach. This allows users to evaluate the different agent configurations according to the metrics that interest the user, without necessarily performing full testing of each potential configuration. Rather, analysis can be performed on data that is sampled adaptively so that adequate testing data is obtained for each potential agent configuration. In addition, data obtained using one agent configuration can be leveraged to infer how other agent configurations would perform, thus allowing the reuse of testing data.

Note that the data gathering and data analysis aspects disclosed herein can be employed cooperatively or independently. Taking the data gathering aspects first, recall that a conventional A/B test would involve taking an equal number of samples for each agent configuration being evaluated. Now, consider a scenario where a third party has an automated evaluation system that employs conventional A/B test data to evaluate different agents. Each time the sampler assigns a given experimental unit to a given agent configuration, that agent configuration consumes computing resources such as processor cycles, memory, storage, and/or network bandwidth.

By using the adaptive sampling techniques described above, a data sample with relatively fewer samples can be used with the third party evaluation system to achieve comparable results. As a consequence, fewer computing resources (e.g., processor cycles and storage bytes) are used to obtain comparable evaluations of different agents. More specifically, by cultivating data samples using the aforementioned second or third sampling modes, the resulting data sample can be used to make higher-confidence predictions as to the performance of various agent configurations than a naive sampling approach as in conventional A/B testing. Thus, the disclosed adaptive sampling mechanisms can use fewer processing or storage resources that would be needed in conventional A/B testing because conventional A/B testing data provides less average predictive information per sample. Said another way, when a data structure such as performance prediction table 400 is populated using the disclosed adaptive sampling techniques, fewer computing resources are involved in testing alternative agent configurations than when traditional A/B testing is employed.

Taking the data analysis aspects next, recall that the disclosed implementations can estimate the performance of an agent with respect to an evaluation metric using a data sample that was logged by a different agent. As a consequence, it is possible to “reuse” individual samples taken by one agent to evaluate multiple other agents, even agents that were not necessarily employed during sampling. Thus, instead of expending processor cycles and/or storage resources to adequately sample each agent individually, the disclosed data analysis techniques can preserve these resources by making predictive inferences about one agent based on samples collected by another agent. Said another way, when a data structure such as performance prediction table 400 is used to infer the performance of a given agent using an event collected by a different agent, fewer computing resources are involved in testing alternative agent configurations than when traditional A/B testing is employed.

Furthermore, recall that the data analysis techniques described herein can be implemented by replaying the events in the event log with different agent configurations. As a consequence, the different agent configurations can be evaluated offline, in some cases without even sampling those different agent configurations. In fact, even new agent configurations that may not have been in existence when the event log was created can still be analyzed using the disclosed techniques. Said another way, a data structure such as performance prediction table 400 allows for offline evaluation of new agent configurations without necessarily even collecting any samples by the new agent configurations. This can be particularly useful for scenarios where users wish to evaluate prototypes of agent configurations that may not be fully vetted for use in production environments. For instance, users can rapidly prototype different potential agent configurations so that they are sufficient to determine action probabilities. These rapid prototypes may have unresolved security, privacy, or performance issues that preclude them from being used in production code, but they can nevertheless be evaluated using events handled by other production-ready agents. As a consequence, developers can focus their efforts on promising prototypes without needing to complete development of less-promising configurations, thus saving the development effort of testing/modifying those less-promising prototypes for security, privacy, and performance reasons.

In addition, note that new evaluation metrics can be defined after the creation of the event logs. For instance, assume the event log is created using any of the three sampling modes described above, and later a user determines a new evaluation metric of interest. The events in the log can be replayed to generate performance predictions for the new evaluation metric, e.g., a new column in performance prediction table 400. The fact that the evaluation metric was not used to sample the event logs does not prevent the agents from being evaluated according to the new evaluation metric. If the confidence intervals for the new evaluation metric are too large, some additional sampling in the third sampling mode using the new evaluation metric can be employed to reduce those confidence intervals so that an appropriate agent configuration can be selected. In contrast, conventional A/B testing would require a full new test of each agent configuration with respect to the new evaluation metric, and in turn would thus involve expending further processing and storage resources that can saved using the disclosed data sampling and/or analysis techniques to populate and/or evaluate a data structure such as performance prediction table 400.

### Example System

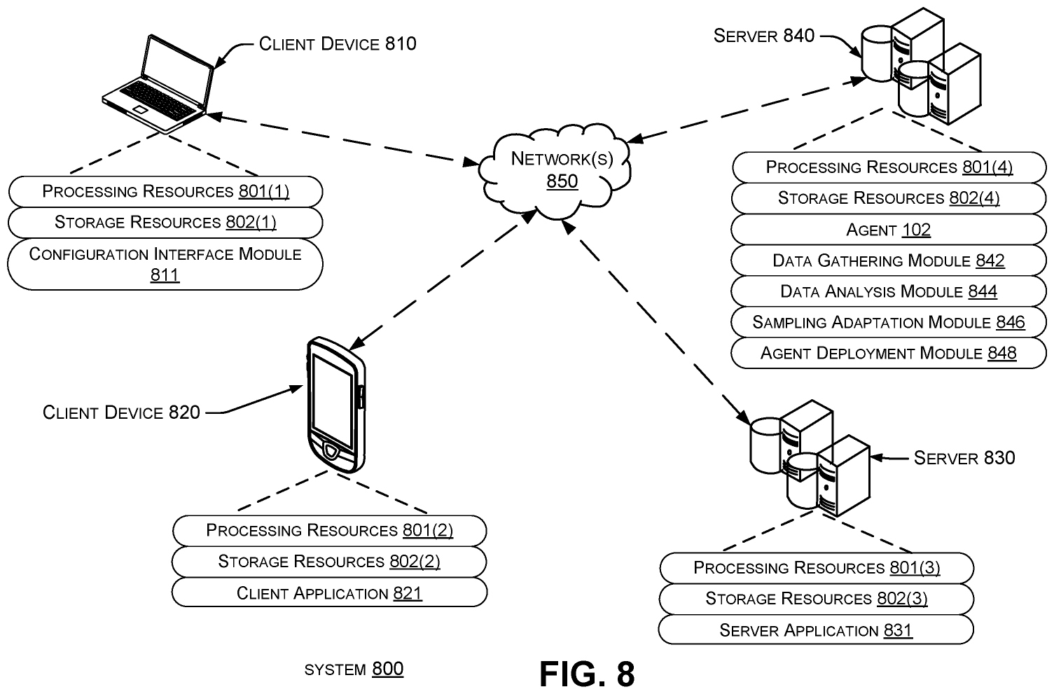

The present implementations can be performed in various scenarios on various devices. FIG. 8 shows an example system 800 in which the present implementations can be employed, as discussed more below.

As shown in FIG. 8, system 800 includes a client device 810, a client device 820, a server 830, and a server 840, connected by one or more network(s) 850. Note that the client devices can be embodied both as mobile devices such as smart phones or tablets, as well as stationary devices such as desktops, server devices, etc. Likewise, the servers can be implemented using various types of computing devices. In some cases, any of the devices shown in FIG. 8, but particularly the servers, can be implemented in data centers, server farms, etc.

Certain components of the devices shown in FIG. 8 may be referred to herein by parenthetical reference numbers. For the purposes of the following description, the parenthetical (1) indicates an occurrence of a given component on client device 810, (2) indicates an occurrence of a given component on client device 820, (3) indicates an occurrence of a given component on server 830, and (4) indicates an occurrence of a given component on server 840. Unless identifying a specific instance of a given component, this document will refer generally to the components without the parenthetical.

Generally, the devices 810, 820, 830, and/or 840 may have respective processing resources 801 and storage resources 802, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Server 840 can include agent 102, data gathering module 842, data analysis module 844, sampling adaptation module 846, and agent deployment module 848. The data gathering module can generate an event log by sampling different agent configurations, e.g., using data gathering workflow 200 described above. The data analysis module can process the event log using one or more alternative agent configurations to determine evaluation metric predictions for each alternative agent configuration, e.g., using data analysis workflow 300 described above. The sampling adaptation module can adjust the sampling strategy used by the data gathering module for the next data gathering iteration as described above with respect to any of the three sampling modes. The agent deployment module can select one of the alternative agent configurations either manually based on user input or automatically based on the evaluation metric predictions, and deploy the agent with the selected agent configuration. One way for the agent configuration module to automatically select an agent configuration is to randomly sample from a Pareto frontier of agent configurations based on predicted performance for one or more evaluation metrics.

In other cases, the agent deployment module 848 can output a graphical user interface, such as shown above in FIGS. 6A, 6B, and/or 6C, that conveys information about each alternative agent configuration to client device 810. Client device 810 can include a configuration interface module 811 that displays the GUI to a user and receives input selecting a particular configuration from the GUI. The client device can send a communication to server 840 that identifies the selected agent configuration, and agent deployment module 848 on server 840 can deploy agent 102 according to the selected configuration.

Server 830 can have a server application 831 that can make API calls to agent 102 on server 840. For instance, a user on client device 820 may be using a client application 821 that interacts with the server application. The server application can send, via the API call, context information and/or action information to the agent 102 on server 840, reflecting context on client device 820 and potential actions that the server application can take. The agent can select a particular action, the server application can perform the selected action, and then the server application can inform the agent of how the client device reacted to the selected action. When the agent is a reinforcement learning agent, the agent can calculate its own reward and potentially update its policy based on the reaction. When the agent is a supervised learning agent, the agent can update its own internal parameters given a label provided by a human or automated entity, where the label can be based on the reaction.

### Example Method

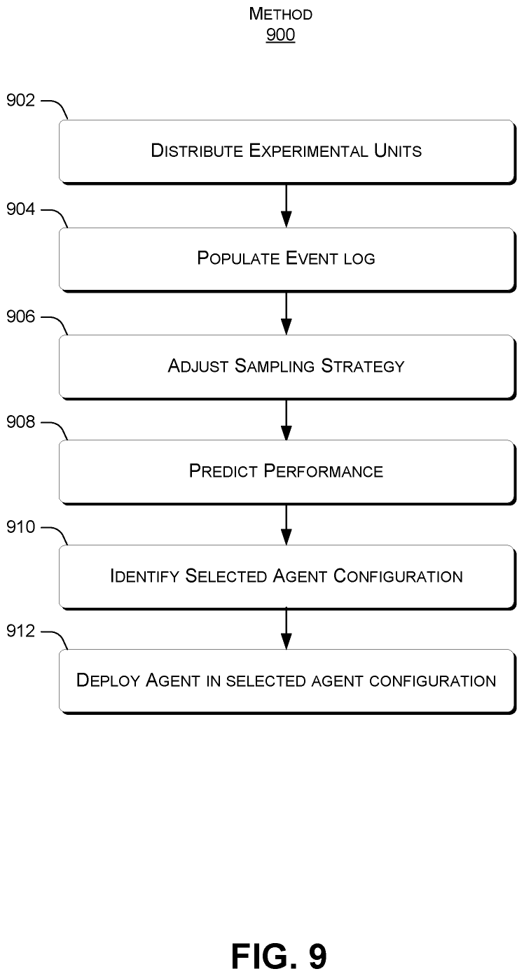

FIG. 9 illustrates an example method 900, consistent with some implementations of the present concepts. Method 900 can be implemented on many different types of devices, e.g., by one or more cloud servers, by a client device such as a laptop, tablet, or smartphone, or by combinations of one or more servers, client devices, etc.

Method 900 begins at block 902, where experimental units are distributed to agents having different agent configurations according to a sampling strategy.

Method 900 begins at block 904, where an event log is populated with events. Events in the event log represent reactions of the environment to various actions taken by individual agents in response to individual experimental units. The events can also represent the context under which those actions were taken, and/or the probabilities assigned by the agents to those actions.

Method 900 continues at block 906, where the sampling strategy is adjusted for a next data gathering iteration. As noted previously, the sampling strategy can be adjusted based on events in the event log. Collectively, blocks 902, 904, and 906 can correspond to a data gathering iteration. Each subsequent data gathering iteration can use an adjusted sampling strategy based on the data sampled in previous data gathering iterations.

Method 900 continues at block 908, where the performance of alternative agent configurations is predicted for one or more evaluation metrics. Values of each of the events for a given evaluation metric can be determined for each event in the event log, based on a function that maps the reactions of the environment (and potentially the selected actions and/or context) to the values of the evaluation metric.

Method 900 continues at block 908, where a selected agent configuration is identified based at least on the predicted performance. For instance, the selected agent configuration can be selected automatically, or responsive to user input identifying the selected agent configuration from a GUI or other user interface.

Method 900 continues at block 912, where an agent is deployed according to the selected agent configuration.

Blocks 902 and 904 can be performed by data gathering module 842. Block 906 can be performed by the sampling adaptation module 846. Block 908 can be performed by the data analysis module 844. Blocks 910 and 912 can be performed by agent deployment module 848.

### Use Case Concerning Electronic Content Distribution

The disclosed implementations are generally applicable to a wide range of real-world problems that can be solved using automated agents. The following presents a specific use case where a given entity wishes to select an agent configuration for distribution of electronic content.

For the purposes of this example, server application 831 on server 830 can be an application that presents electronic content items to a user of client device 820 by outputting identifiers of the electronic content items to client application 821. Agent 102 can be an agent that receives an API call from the server application, where the API call identifies multiple different potential electronic content items to the agent as well as context reflecting the environment in which the electronic contents will be presented to users. Each potential electronic content item is a potential action for the agent. The agent can select a particular content item for the application to output to the user.

Assume that a user that oversees a video game platform would like to encourage more engagement by different video game players with each other. However, also assume that this user does not necessarily care which video games that players actually play, only that they engage with the video game platform by comments, likes, or interactions with other video game players. Now, consider a specific video game player that likes to play driving video games and has never played any sports video games.

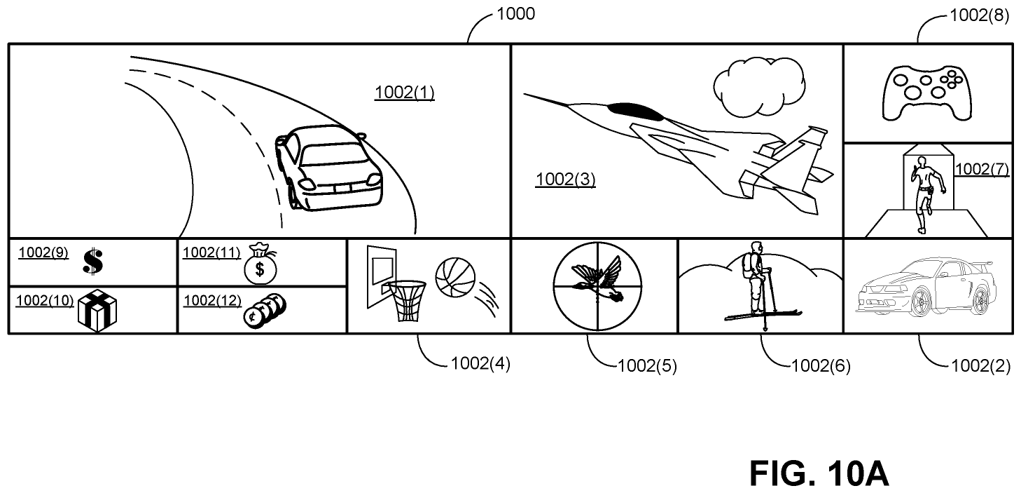

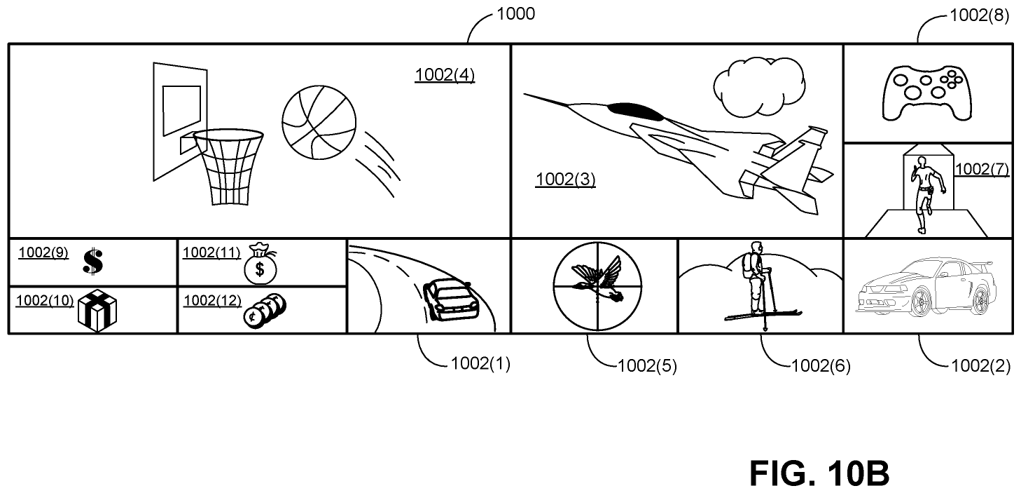

Because this video game player has played lots of hours of driving games, the agent may tend to continue prioritizing driving video games to this video game player. FIG. 10A illustrates an electronic content GUI 1000 with various electronic contents 1002(1)-1002(12) shown to the user. Here, a driving game 1002(1) is selected by the agent as the highest-ranking content item according to the previous agent configuration. This could be a previous rule-based agent configuration that uses a heuristic weighting scheme with static weights to select games based on how long a user has previously played similar games, a previous supervised learning agent that was trained using labeled training data with positive labels for when users played driving video games, or a previous reinforcement learning agent that calculates its own rewards based on how long users play the games that it recommends. Because the agent recommends the driving video game, the application outputs the driving game in the largest section of the display area. Note that sports video game 1002(4) is also shown but occupies much less screen area.

Now, assume that players of driving video games tend to engage with the video game platform infrequently, e.g., they tend not to communicate with each other or give “likes” to specific games or game scenarios. Further, assume that players of sports games are far more likely to engage with the video game platform. This could be, for instance, because sports games have structured breaks such as timeouts, halftime, etc., that allow time for users to engage more with the platform. Thus, when various agent configurations are evaluated for an evaluation metric related to engagement, it follows that those agent configurations that tend to recommend more sports games will tend to increase engagement relative to those that recommend driving video games.

FIG. 10B illustrates electronic content GUI 1000 in an alternative configuration using an agent configuration selected according to the disclosed implementations. Now, sports video game 1002(4) occupies the largest area of the screen. This can be a result of a new agent configuration having a different heuristic weighting scheme, a different loss function, or a different reward function that encourages selection of sports video games and discourages playing driving video games.

Note that, in this example, the user specifying the new agent configuration did not need to specifically modify, evaluate, or understand the internal functioning of the underlying agent. For instance, the user does not need to specify heuristic rules, a supervised learning algorithm or loss function, or a reinforcement learning model or a reward function in order to encourage the agent to select sports games over driving games. Rather, the user was concerned with engagement rather than the types of games that users were playing or the underlying technical details of the agent.

By replaying the event log through various agent configurations, the disclosed techniques can discover agent configurations with good performance for metrics of interest to the user, without requiring the user to determine how the agent itself is configured. Thus, in this example, the user is able to select an agent configuration that encourages engagement, without necessarily even needing to recognize that sports games tend to encourage engagement, much less needing to manually define an agent configuration that encourages the agent to select sports games.

As another example, assume that the agent was previously configured with a reinforcement or supervised learning agent using a very conservative learning rate hyperparameter. Thus, the agent may tend to continue recommending the same video games to the players that they have played in the past, even if they have recently begun to play new video games. In other words, the conservative learning rate hyperparameter causes the agent to react rather slowly to changing preferences of the players.

Now, assume that players who play video games for the first few times tend to engage with the platform more frequently than players who continue to play games they have played previously. Because the agent adapts slowly, the previous agent configuration may inadvertently tend to discourage engagement, even if the previous agent configuration tends to result in a lot of overall video game play. This is because the slow learning rate discourages the agent from reacting when the players start playing new video games, thus referring the user back to video games they have played frequently in past.

Now, assume that a user selects a new agent configuration with a very high predicted engagement value. The new agent configuration may have a much faster learning rate than the old agent configuration. Because the learning rate is faster, the agent may react quickly when the players start playing new games, e.g., recommending the new games over older games previously played by the user even after the users have only played the new games one or two times. However, the user selecting the new agent configuration does not need to know this—the user only knows that the new agent configuration will tend to increase engagement.

As another example, assume that the agent has been configured with a feature definition that considers only features relating to video games that players have played in the past. Thus, the agent may not consider other characteristics of players when recommending video games, such as other interests that the players may have. On the other hand, it could be true that video game players with shared common interests tend to interact with each other more frequently when playing video games, even if those interactions are not necessarily related to game play. For instance, a group of players of an online basketball game may find that they also share an interest in politics and discuss politics when playing the basketball game.

Now, assume that a user selects a new agent configuration with a very high predicted engagement value. The new agent configuration may have a feature definition that considers other interests of the video game players, e.g., whether the players are members of topic-specific online social media groups (e.g., politics), etc. Because this feature definition enables the agent to consider user context that conveys external interests of the video game players, the new agent configuration increases engagement compared to the previous configuration that did not consider external user interests. Again, the user selecting the new configuration does not necessarily need to be concerned with what features the agent uses in the new configuration, only that the new configuration tends to increase engagement relative to the previous or other alternative agent configurations.

### Further Context Features for Content Distribution

One type of context vector useful for content distribution, such as distribution of video games or streaming media, is a user vector characterizing one or more characteristics of a particular user. There are many different ways to describe or define a user as a set of features or signals. The characteristics of the user may include fixed user features such as, a user identifier (e.g., user gaming identifier), age, gender, location, sexual orientation, race, language, and the like. The characteristics of the user can also include dynamic user features, for example, purchase tendency, genre affinity, publisher affinity, capability affinity, social affinity, purchase history, interest history, wish list history, preferences, social media contacts or groups, and characteristics of the user's social media contexts or groups. There may be a very high number of features or signals in a user vector. A feature generator may generate a user vector that includes one or more user features for each user. Other context features can represent the time of the day, the day of the week, the month of the year, a season, a holiday, etc. In some implementations, the user information can be maintained in a privacy preserving manner.

Each available item of content is a potential action for the agent. In other words, the agent can choose to recommend any specific item of content given a current context of the environment, according to the agent's current policy. Thus, in this case, the action features can be represented as content vectors for each of a plurality of contents (e.g., games, movies, music, etc.) The content information may be manually provided or obtained from a database of contents. There are many different ways to describe or characterize content. A content vector can include a plurality of characteristics of a specific content (e.g., a particular game), for example, text about the content, metadata regarding the content, pricing information, toxicity, content rating, age group suitability, genre, publisher, social, the number of users, etc. The feature generator can generate metrics for the various features related to content, such as an inclusiveness metric, a safety metric, a toxicity metric, etc.

Each time the agent chooses an action, e.g., outputs a content item to the user, the environment reacts. For instance, the user can click on a content item, ignore the content item, etc. For example, user reactions can include viewing content, selecting content, clicking on content or any other item on the display screen, purchasing, downloading, spending money, spending credits, commenting, sharing, hovering a pointer over content, playing, socializing, failing to select any of the personalized contents (e.g., within a predefined period of time), minimizing, idling, exiting the platform (e.g., a game store), etc. Any of these user actions can be represented by corresponding reaction features.

Note that some implementations may also consider various context features that characterize the client device being used to consume electronic content. For instance, the agent may be provided with context features identifying a processing unit of the client device, whether the client device has a particular type of hardware acceleration capability (e.g., a graphics processing unit), amount of memory or storage, display resolution, operating system version, etc. In this case, the agent may learn that certain games or other executables cannot run, or run poorly, on devices that lack certain technical characteristics. For instance, referring back to FIG. 10A, the agent may learn that the driving game 1002(1) does not run well on devices with less than a specified amount of RAM, and can instead learn to select sports game 1002(4).

The environmental reaction measured by the agent can be a result of the user intentionally ending the game in a short period of time, or an explicit signal from the client device such as measuring memory or CPU utilization. Thus, for instance, the agent might learn that device type A (e.g., lacking a GPU but having a lot of RAM) exhibits high CPU utilization when executing driving game 1002(1), device type B (e.g., having a GPU but lacking enough RAM) exhibits high memory utilization when executing driving game 1002(1), and device type C exhibits moderate memory and CPU utilization when executing the driving game. Thus, the agent may learn to recommend the sports video game 1002(4) to devices of type A and B, while recommending the driving video game to devices of type C.

### Use Case for Video Call Applications

For the purposes of this example, server application 831 can be an application that provides video call functionality to users of client application 821 on client device 820. Agent 102 can be an agent that receives an application programming interface (API) call from the application, where the API call identifies multiple different technical configurations to the agent as well as context reflecting the technical environment in which video calls will be conducted. Each technical configuration is a potential action for the agent. The agent can return the highest-ranked configuration to the application.

One example of a potential technical configuration for a video call application is the playout buffer size. A playout buffer is a memory area where VOIP packets are stored, and playback is delayed by the duration of the playout buffer. Generally, the use of playout buffers can improve sound quality by reducing the effects of network jitter. However, because sound play is delayed while filling the buffer, conversations can seem relatively less interactive to the users if the playout buffer is too large. However, large playout buffers imply a longer delay from packet receipt until the audio/video data is played for the receiving user, which can result in perceptible conversational latency.

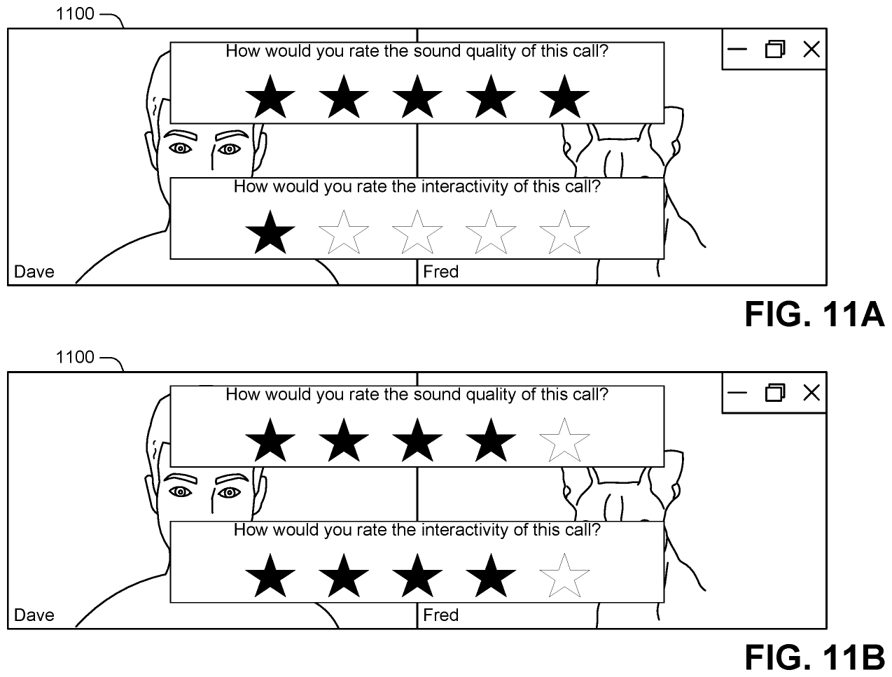

Generally speaking, any agent that encourages high sound quality without considering interactivity can tend to prioritize large playout buffers. FIG. 11A illustrates a video call GUI 1100 with high sound quality ratings, but low interactivity ratings, which reflects how a human user (e.g., of client device 820) might perceive call quality using such a configuration. This could be due to a rule-based agent that specifies large playout buffers in all circumstances, due to a supervised learning agent trained on labeled training data with labels that characterize only sound quality, or a reinforcement learning agent that has been configured with a reward function that calculates rewards based solely on whether the playout buffer ever becomes empty, e.g., playback needs to be paused while waiting for new packets.

Now assume that a new agent configuration is selected. The new agent configuration could be a rules-based agent that configures the playout buffer size as a static mathematical function of variables such as average packet latency. The new agent configuration could be a supervised learning agent trained using training data with labels that characterize interactivity as well as sound quality. The new agent configuration could be a reinforcement learning agent with a different reward function that considers both whether the playout buffer becomes empty as well as the duration of the calls. Any of these agents may tend to choose a moderate-size playout buffer that provides reasonable call quality and interactivity. FIG. 11B illustrates video call GUI 1100 with relatively high ratings for both sound quality and interactivity.

A user who is selecting an agent configuration for this scenario might consider evaluation metrics such as call quality or interactivity, since these are the aspects of the call that are important to end users. Such a user may not have a great deal of technical expertise and might have a difficult time specifying an agent configuration to achieve this goal. Nevertheless, the user can implicitly choose an agent configuration that successfully achieves a balance between interactivity and call quality by specifying their evaluation metric in an intuitive manner.

With respect to feature definitions, one feature that an agent might consider is network jitter, e.g., the variation in time over which packets are received. Jitter can be measured over any time interval, e.g., the variation in packet arrival times can be computed over just a few packets or over a longer duration (e.g., an entire call). Consider a previous agent configuration that uses a feature definition for network jitter computed over a large number of packets. If network jitter suddenly changes, it may take an agent a long time to recognize the change and make corresponding changes to the size of the playout buffer. A new agent configuration that uses a measure of jitter computed over a shorter period of time may result in better sound quality and interactivity. Here again, the user does not need to explicitly configure the agent to use a specific feature definition for jitter. Rather, various feature definitions can be evaluated using the event log to determine how they will impact sound quality and interactivity, and the user can simply pick whichever configuration balances sound quality and interactivity according to their preferences. This implicitly allows the user to specify a feature definition for jitter without manually defining such a feature.

The context features, action features, and reaction features for voice call applications can be different than those used for content personalization. For instance, context features might represent the location and identities of parties on a given call, whether certain parties are muting their microphones or have turned off video, network jitter and delay, whether users are employing high-fidelity audio equipment, whether a given user is sending multicast packets, etc. Action features might describe the size of the playout buffer as well as any other parameters the agent may be able to act on, e.g., VOIP packet size, codec parameters, etc. Reaction features might represent buffer over- or under-runs, quiet periods during calls, call duration, etc. In some cases, automated characterization of sound quality or interactivity can be employed to obtain reaction features or labels for supervised learning, e.g., Rix et al., “Perceptual Evaluation of Speech Quality (PESQ)—A New Method for Speech Quality Assessment of Telephone Networks and Codecs,” 2001 IEEE International Conference on Acoustics, Speech, and Signal Processing. Proceedings, 2001.

### Device Implementations

As noted above with respect to FIG. 8, system 800 includes several devices, including a client device 810, a client device 820, a server 830, and a server 840. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 850. Without limitation, network(s) 850 can include one or more local area networks (LANs), wide area networks (WANs), the Internet, and the like.

Various examples are described above. Additional examples are described below. One example includes a method comprising performing two or more data gathering iterations comprising distributing experimental units to a plurality of agents having different agent configurations, the experimental units being distributed according to a sampling strategy, populating an event log with events representing reactions of an environment to actions taken by individual agents in response to individual experimental units, and based at least on the events in the event log, adjusting the sampling strategy for use in a subsequent data gathering iteration, based at least on the events in the event log, predicting performance of the plurality of agents with respect to one or more evaluation metrics, and based at least on predicted performance of the plurality of agents with respect to the one or more evaluation metrics, identifying a selected agent configuration.

Another example can include any of the above and/or below examples where the method further comprises deploying a selected agent having the selected agent configuration.

Another example can include any of the above and/or below examples where the selected agent configuration is selected automatically or based on user input identifying the selected agent configuration from a graphical representation of the predicted performance of the plurality of agents.

Another example can include any of the above and/or below examples where the method further comprises determining importance weights of the individual agents based at least on corresponding probabilities that individual agents give to the actions relative to probabilities of the actions taken by other agents that are stored in the event log, and adjusting the sampling strategy based at least on the importance weights.

Another example can include any of the above and/or below examples where the method further comprises calculating respective sampling probabilities for the individual agents based at least on the importance weights.

Another example can include any of the above and/or below examples where adjusting the sampling strategy comprises removing at least one agent from subsequent data gathering iterations based at least on the importance weights.

Another example can include any of the above and/or below examples where the sampling strategy is adjusted at each data gathering iteration based at least on the predicted performance of the plurality of agents with respect to the one or more evaluation metrics.

Another example can include any of the above and/or below examples where adjusting the sampling strategy comprises determining respective confidence intervals of the one or more evaluation metrics for each of the plurality of agents, and calculating sampling probabilities of individual agents based at least upper bounds of the confidence intervals.

Another example can include any of the above and/or below examples where adjusting the sampling strategy comprises removing at least one agent from further sampling based at least on the predicted performance.

Another example can include any of the above and/or below examples where the method further comprises populating a data structure with predicted aggregate values and corresponding confidence intervals for the one or more evaluation metrics, outputting a graphical representation of the data structure, and identifying one or more agent configurations to sample in a subsequent data gathering iteration based at least on user input directed to the graphical representation of the data structure.

Another example can include any of the above and/or below examples where the method further comprises receiving user input specifying two or more evaluation metrics, and generating the graphical representation based at least on the two or more evaluation metrics specified by the user input.

Another example can include any of the above and/or below examples where the method further comprises using the events in the event log, predicting performance of at least one other agent with respect to the one or more evaluation metrics, wherein the at least one other agent was not sampled when populating the event log.

Another example includes a system comprising a processor, and a storage resource storing instructions which, when executed by the processor, cause the system to perform two or more data gathering iterations comprising distributing experimental units to a plurality of agents having different agent configurations, the experimental units being distributed according to a sampling strategy, populating an event log with events representing reactions of an environment to actions taken by individual agents in response to individual experimental units, and based at least on the events in the event log, adjusting the sampling strategy for use in a subsequent data gathering iteration, wherein the event log provides a basis for subsequent evaluation of the plurality of agents with respect to one or more evaluation metrics.

Another example can include any of the above and/or below examples where the individual agents include machine learning agents having different hyperparameters or different feature definitions.

Another example can include any of the above and/or below examples where the individual agents include at least two different reinforcement learning agents having different reward functions, at least two different supervised learning agents having different loss functions, and at least two different rule-based agents having different rules.

Another example can include any of the above and/or below examples where the sampling strategy is based at least on respective importance weights of the individual agents.

Another example can include any of the above and/or below examples where the sampling strategy is adjusted based at least on predicted performance of the plurality of agents with respect to the one or more evaluation metrics.

Another example can include any of the above and/or below examples where adjusting the sampling strategy comprises assigning respective probabilities to individual agents and randomly assigning the experimental units to the individual agents based on the respective probabilities.

Another example includes a computer-readable storage medium storing instructions which, when executed by a computing device, cause the computing device to perform acts comprising obtaining an event log of events representing reactions of an environment to actions taken by a plurality of agents in response to individual experimental units, predicting performance of individual agents with respect to one or more evaluation metrics based at least on respective events in the event log reflecting respective actions taken by other agents, based at least on predicted performance of the individual agents with respect to the one or more evaluation metrics, identifying a selected agent configuration, and deploying a selected agent having the selected agent configuration.

Another example can include any of the above and/or below examples where the events of the event log are previously sampled using an adaptive sampling strategy that adjusts sampling probabilities of respective agents based on collected events.

Another example can include can include any of the above and/or below examples where the selected agent, when deployed in the selected agent configuration, receives an application programming interface call from an application and selects a technical configuration for the application in response to the application programming interface call.

Another example can include any of the above and/or below examples where the application is a voice or video call application and the technical configuration indicates a buffer size of a playout buffer for the application.

Another example can include any of the above and/or below examples where the selected agent is a reinforcement learning agent and the selected agent configuration includes a selected reward function that considers both whether the playout buffer becomes empty and respective durations of voice or video calls.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
performing two or more data gathering iterations comprising:
distributing experimental units to a plurality of agents having different agent configurations, the experimental units being distributed according to a sampling strategy;
populating an event log with events representing reactions of an environment to actions taken by individual agents in response to individual experimental units; and
based at least on the events in the event log, adjusting the sampling strategy for use in a subsequent data gathering iteration;
based at least on the events in the event log, predicting performance of the plurality of agents with respect to one or more evaluation metrics; and
based at least on predicted performance of the plurality of agents with respect to the one or more evaluation metrics,
identifying a selected agent configuration.

2. The method of claim 1, further comprising:
deploying a selected agent having the selected agent configuration.

3. The method of claim 2, wherein the selected agent configuration is selected automatically or based on user input identifying the selected agent configuration from a graphical representation of the predicted performance of the plurality of agents.

4. The method of claim 1, further comprising:
determining importance weights of the individual agents based at least on corresponding probabilities that individual agents give to the actions relative to probabilities of the actions taken by other agents that are stored in the event log; and
adjusting the sampling strategy based at least on the importance weights.

5. The method of claim 4, further comprising:
calculating respective sampling probabilities for the individual agents based at least on the importance weights.

6. The method of claim 4, wherein adjusting the sampling strategy comprises:
removing at least one agent from subsequent data gathering iterations based at least on the importance weights.

7. The method of claim 1, wherein the sampling strategy is adjusted at each data gathering iteration based at least on the predicted performance of the plurality of agents with respect to the one or more evaluation metrics.

8. The method of claim 7, wherein adjusting the sampling strategy comprises:
determining respective confidence intervals of the one or more evaluation metrics for each of the plurality of agents; and
calculating sampling probabilities of individual agents based at least upper bounds of the confidence intervals.

9. The method of claim 7, wherein adjusting the sampling strategy comprises:
removing at least one agent from further sampling based at least on the predicted performance.

10. The method of claim 7, further comprising:
populating a data structure with predicted aggregate values and corresponding confidence intervals for the one or more evaluation metrics;
outputting a graphical representation of the data structure; and
identifying one or more agent configurations to sample in a subsequent data gathering iteration based at least on user input directed to the graphical representation of the data structure.

11. The method of claim 10, further comprising:
receiving user input specifying two or more evaluation metrics; and
generating the graphical representation based at least on the two or more evaluation metrics specified by the user input.

12. The method of claim 1, further comprising:
using the events in the event log, predicting performance of at least one other agent with respect to the one or more evaluation metrics, wherein the at least one other agent was not sampled when populating the event log.

13. A system comprising:
a processor; and
a storage resource storing instructions which, when executed by the processor, cause the system to:
perform two or more data gathering iterations comprising:
distributing experimental units to a plurality of agents having different agent configurations, the experimental units being distributed according to a sampling strategy;
populating an event log with events representing reactions of an environment to actions taken by individual agents in response to individual experimental units; and
based at least on the events in the event log, adjusting the sampling strategy for use in a subsequent data gathering iteration,
wherein the event log provides a basis for subsequent evaluation of the plurality of agents with respect to one or more evaluation metrics.

14. The system of claim 13, wherein the individual agents include machine learning agents having different hyperparameters or different feature definitions.

15. The system of claim 13, wherein the individual agents include at least two different reinforcement learning agents having different reward functions, at least two different supervised learning agents having different loss functions, and at least two different rule-based agents having different rules.

16. The system of claim 13, wherein the sampling strategy is based at least on respective importance weights of the individual agents.

17. The system of claim 13, wherein the sampling strategy is adjusted based at least on predicted performance of the plurality of agents with respect to the one or more evaluation metrics.

18. The system of claim 13, wherein adjusting the sampling strategy comprises assigning respective probabilities to individual agents and randomly assigning the experimental units to the individual agents based on the respective probabilities.

19. A computer-readable storage medium storing instructions which, when executed by a computing device, cause the computing device to perform acts comprising:
obtaining an event log of events representing reactions of an environment to actions taken by a plurality of agents in response to individual experimental units;
predicting performance of individual agents with respect to one or more evaluation metrics based at least on respective events in the event log reflecting respective actions taken by other agents;
based at least on predicted performance of the individual agents with respect to the one or more evaluation metrics, identifying a selected agent configuration; and
deploying a selected agent having the selected agent configuration.

20. The computer-readable storage medium of claim 19, wherein the events of the event log are previously sampled using an adaptive sampling strategy that adjusts sampling probabilities of respective agents based on collected events.
